(19) United States
(12) Patent Application Publication
(10) Pub. No.: US 2025/0164382 A1
(43) Pub. Date: May 22, 2025

(54) INFORMATION PROCESSING DEVICE

(71) Applicant: TOYOTA JIDOSHA KABUSHIKI KAISHA, Totota-shi (JP)

(72) Inventors: Hideaki Bunazawa, Tokyo (JP); Atsushi Tabata, Okazaki-shi (JP); Koichi Okuda, Totota-shi (JP); Yuuki Makino, Aichi-gun (JP)

(73) Assignee: TOYOTA JIDOSHA KABUSHIKI KAISHA, Toyota-shi (JP)

(21) Appl. No.: 18/937,459

(22) Filed: Nov. 5, 2024

(30) Foreign Application Priority Data
Nov. 16, 2023 (JP) 2023-195061

(51) Int. Cl. G01N 19/02

(52) U.S. Cl. CPC G01N 19/02

(57) ABSTRACT

The processing device of the information processing device includes: a first step of calculating a relative frequency distribution of the original data; a second step of setting time windows for clipping data of a part of the period of the original data; a third step of clipping data from the original data; a fourth step of calculating a relative frequency distribution in the extracted data; and a fifth step of calculating an error between the relative frequency distribution in the original data and the relative frequency distribution in the extracted data, and performs a search process of repeatedly performing the trial from the second step to the fifth step by changing the setting of the time windows. The processing device calculates an index value of the damage of the friction material of the transmission using the extracted data in which the error becomes the threshold value or smaller.

### CROSS-REFERENCE TO RELATED APPLICATION

This application claims priority to Japanese Patent Application No. 2023-195061 filed on Nov. 16, 2023, incorporated herein by reference in its entirety.

### BACKGROUND

### 1. Technical Field

The present disclosure relates to information processing devices.

### 2. Description of Related Art

Japanese Unexamined Patent Application Publication No. 2008-108247 (JP 2008-108247 A) discloses an information processing device that reduces the size of data for analysis by compressing original data for analysis. The original data for analysis is data collected over a predetermined period using a sensor mounted on a vehicle.

The information processing device disclosed in JP 2008-108247 A compresses data by extracting, from the original data, data acquired at the time when a certain vehicle speed is reached and data acquired at the time of an inflection point of the vehicle speed.

### SUMMARY

The above information processing device extracts data by focusing only on the vehicle speed. Therefore, the above information processing device cannot extract data according to characteristics of data other than the vehicle speed. There is a demand for an information processing device capable of obtaining extracted data that captures characteristics of all of the original data including a plurality of features.

An information processing device according to an aspect of the present disclosure is an information processing device that acquires original data collected and created over a predetermined period using a plurality of sensors mounted on a vehicle and calculates an index value indicating a magnitude of damage accumulated in a friction material of a transmission. The information processing device includes a processing device configured to perform a process. The original data includes, as features, data on an amount of heat generation of the friction material of the transmission and data on an engagement frequency of the friction material of the transmission. The processing device is configured to perform a search process, the search process including a first step of calculating, for each of a plurality of features included in the original data, a relative frequency distribution in the original data, a second step of setting a plurality of time windows for clipping data in a partial period of the original data in such a manner that a sum of periods of all the time windows is shorter than the predetermined period, a third step of clipping data from the original data according to the time windows, a fourth step of calculating, for each of the plurality of features, the relative frequency distribution in extracted data obtained by combining all the data clipped according to the time windows, and a fifth step of calculating an error between the relative frequency distribution in the original data and the relative frequency distribution in the extracted data, and after the first step is performed, a trial from the second step to the fifth step being repeatedly performed by changing settings of the time windows, and the processing device performing the search process to extract the extracted data with the error equal to or less than a threshold value, and calculate the index value using the extracted data with the error equal to or less than the threshold value.

In the information processing device according to the above aspect, the processing device may be configured to perform clustering, the clustering being machine learning that groups data of each interval obtained by dividing the original data into intervals of a certain period into a predetermined number of clusters, and the processing device may be configured to set, in the second step, the time windows in such a manner that a difference between a proportion of each cluster in the extracted data and a proportion of each cluster in all of the original data is equal to or less than a threshold value.

The above information processing device uses the extracted data whose data volume is smaller than that of the original data, and can calculate the index value using the extracted data with the same accuracy as in the case where the original data is used. Therefore, the information processing device can reduce the data volume and maintain the accuracy, and can calculate the index value in a shorter time than in the case where the original data is used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing device;

FIG. 2 is a graph showing the original data, wherein the upper row shows the transition of the amount of heat generation of the friction material, and the lower row shows the transition of the engagement frequency of the friction material;

FIG. 3 is a flowchart illustrating a flow of processing performed by the processing device of the data center;

FIG. 4 is a graph showing an example in which original data is clustered using two features;

FIG. 5 is a diagrammatic representation of the relative frequency distribution for the amount of heat generation of the frictional material in the original data; and

FIG. 6 is a graph showing an example of the relative frequency distribution of the engagement frequency of the friction material in the original data.

### DETAILED DESCRIPTION OF EMBODIMENTS

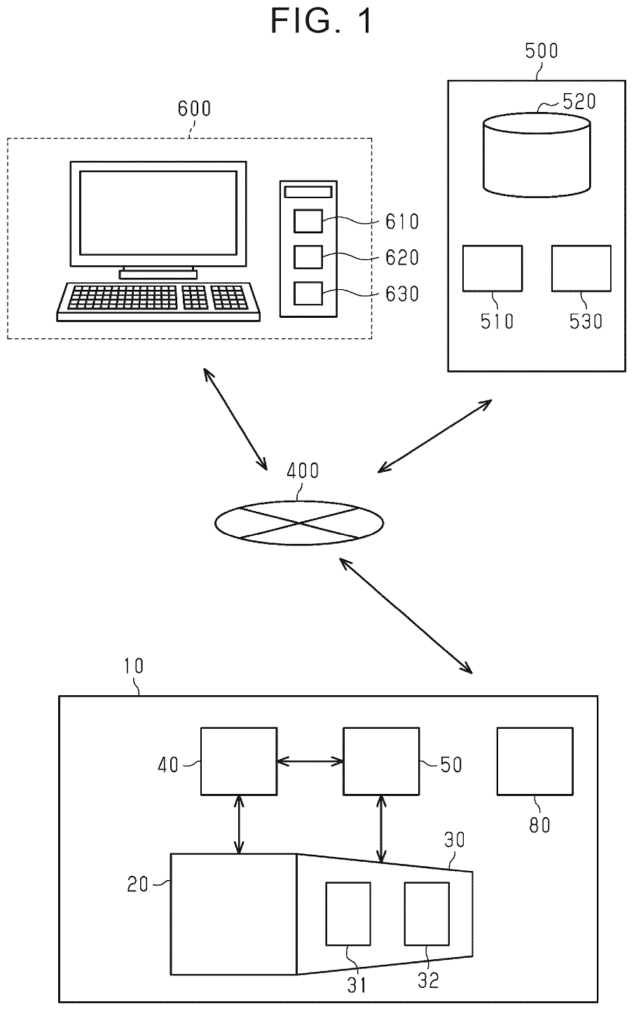

Hereinafter, a data center 500, which is an embodiment of an information processing device, will be described with reference to FIG. 1 to FIG. 6.

### Configuration of Information Processing System

FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of Data Center 500

As illustrated in FIG. 1, the data center 500 includes a processing device 510. The data center 500 includes a storage device 520 and a communication device 530. The processing device 510 includes a CPU that performs processing in accordance with a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

The data center 500 may be configured using a plurality of computers. For example, the data center 500 may be configured by a plurality of server devices.

### Structure of Vehicle 10

Each of the plurality of vehicles 10 includes a communication device 80. The communication devices 80 are implemented as hardware such as a network adapter, various communication software, or a combination thereof. These communication devices 80 are configured to realize wired or wireless communication via the communication network 400.

Each vehicle 10 is equipped with an engine 20 and an automatic transmission 30. For example, the automatic transmission 30 is a planetary gear type transmission. The automatic transmission 30 includes a friction engagement device 31 and a hydraulic pressure control circuit 32. Friction engagement device 31 alters the combination of planetary gear trains that transmit power by engaging or releasing a plurality of frictional engagement elements. Accordingly, the automatic transmission 30 forms a plurality of transmission stages having different gear ratios. The frictional engagement element is, for example, a clutch or a brake. The friction engagement elements each comprise a friction material. The hydraulic pressure control circuit 32 controls the hydraulic pressure supplied to the respective frictional engagement elements of the friction engagement device 31.

The vehicle 10 includes an engine control device 40 and a transmission control device 50. The engine control device 40 controls the engine 20. The transmission control device 50 controls the automatic transmission 30 by controlling the hydraulic pressure control circuit 32.

The engine control device 40 and the transmission control device 50 are equipped with various sensors that collect information on each part of the vehicle 10. In each vehicle 10, travel data is collected from the various sensors. The traveling data is transmitted from each vehicle 10 to the data center 500 by the communication device 80. For example, travel data including the travel distance, the position information, and the vehicle speed of each vehicle 10 is transmitted from each vehicle 10 to the data center 500. The travel data also includes various data indicating the state of the automatic transmission 30 acquired by the transmission control device 50 of the vehicle 10. Identification information for identifying the respective vehicles 10 is also transmitted from the respective vehicles 10 to the data center 500 together with the traveling data.

The data center 500 stores the traveling data together with the received identification information in the storage device 520. In this way, traveling data of the plurality of vehicles 10 is accumulated in the storage device 520 of the data center 500.

### Configuration of Information Processing Terminal 600

The information processing terminal 600 includes a processing device 610, a storage device 620, and a communication device 630. The processing device 610 includes a CPU that performs processing in accordance with a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of Vehicle 10

The information processing terminal 600 is used to analyze travel data. When analyzing the traveling data, an instruction for executing the analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the friction material of the automatic transmission 30 of the specific vehicle 10 based on the traveling data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the characteristics of the entire original data from a large amount of travel data that is the original data. If such extracted data can be extracted, the processing device 510 can perform analysis in a shorter time by using the extracted data. For example, in the case of estimating the damage of the friction material when traveling for 100,000 hours, the processing device 510 estimates the damage using the extracted data for 20,000 hours extracted from the original data for 100,000 hours. The processing device 510 then multiplies the index value calculated from the extracted data for 20,000 hours by 5 to calculate the index value of the damage of the friction material when the vehicle travels for 100,000 hours.

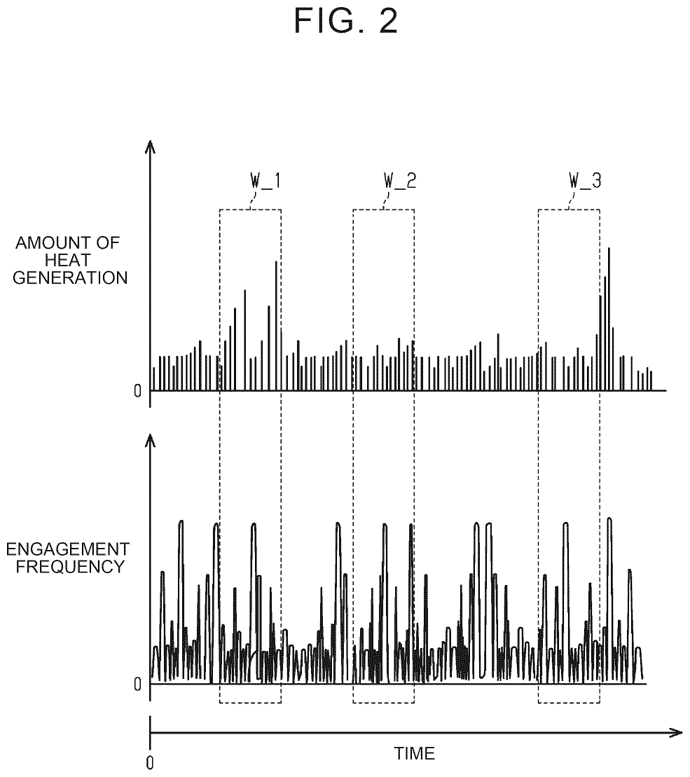

FIG. 2 illustrates an example of original data. The original data illustrated in FIG. 2 is travel data for 100,000 hours in one vehicle 10. The original data illustrated in FIG. 2 includes, as the features, an amount of heat generated by the friction material to be subjected to calculation of the index value of damage and an engagement frequency of the friction material.

The upper part of FIG. 2 shows the transition of the amount of heat generated by the friction material for 100,000 hours. The amount of heat generated by the friction material can be calculated based on the relative rotation speed, which is the difference between the input-side rotation speed and the output-side rotation speed in the friction engagement element, the torque transmitted by the friction engagement element, and the shift time of the automatic transmission 30. The amount of heat generation is calculated by the transmission control device 50. The relative rotational speed, the torque transmitted by the frictional engagement element, and the shift time of the automatic transmission 30 may be transmitted from the vehicle 10 to the data center 500, and the amount of heat generation may be calculated at the data center 500.

The lower part of FIG. 2 shows the transition of the engagement frequency of the friction material for 100,000 hours. The engagement frequency indicates the number of times the friction material is engaged per fixed time. The engagement frequency is calculated by the transmission control device 50. The data in which the timing when the engagement of the friction materials is performed is recorded from the vehicle 10 may be transmitted to the data center 500, and the engagement frequency may be calculated in the data center 500. The engagement frequency may be data indicating an execution interval of the shift using the same friction material.

The amount of heat generation and the engagement frequency correlate with the damage of the friction material of the vehicle 10. The processing device 510 of the data center 500 estimates the damage of the friction material from the travel data including the engagement frequency and the engagement frequency as the feature.

The extracted data is created by clipping the data from the original data by a plurality of time windows. In FIG. 2, as an example of a plurality of time windows, three time windows of the first time window W_1, the second time window W_2, and the third time window W_3 are indicated by broken lines. The beginning and end of each time window are set such that the respective time windows do not overlap. In this example, the traveling data for 20,000 hours is clipped as the extracted data. Therefore, the start and end periods of each time window are set so that the total length of the time periods of all the time windows is 20,000 hours.

The data center 500 searches for the setting of the start time and the end time of each time window indicating the clipping pattern for extracting the extracted data that captures the characteristics of the entire original data.

The data center 500 extracts the extracted data from the original data by using the clipping pattern found by the search. The data center 500 performs analysis using the extracted data.

### Clipping Pattern Search Process

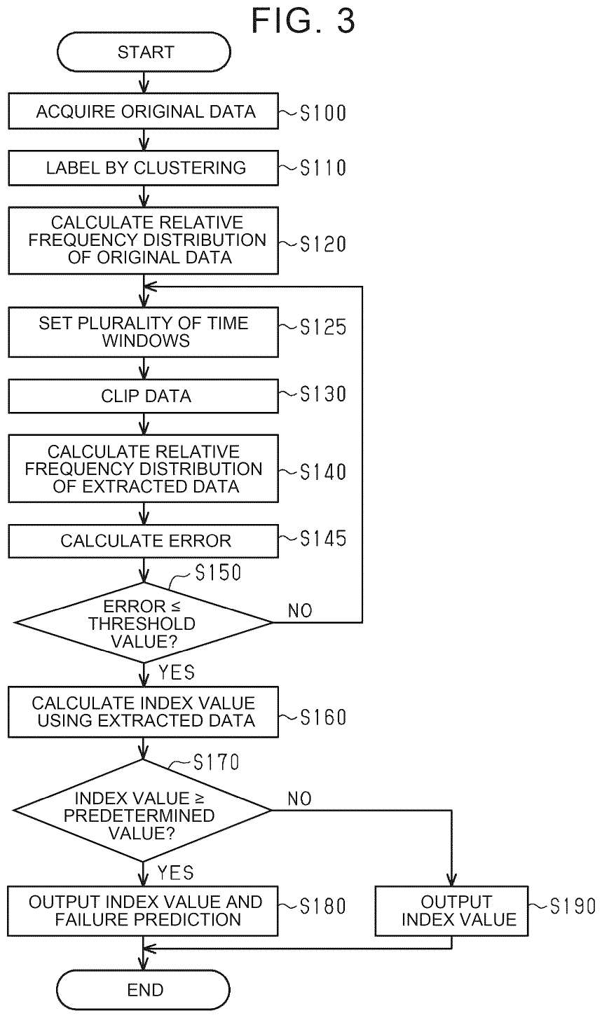

FIG. 3 is a flowchart illustrating a flow of a series of processes related to the clipping pattern search process. This series of processing is performed by the processing device 510 of the data center 500.

As illustrated in FIG. 3, the processing device 510 acquires the original data in the processing of S100. The original data is a part of the travel data selected for the purpose of analysis from the enormous travel data stored in the storage device 520 of the data center 500. For example, the original data for calculating the index value indicating the magnitude of the damage accumulated in the specific friction material of the automatic transmission 30 of one vehicle 10 is travel data over a predetermined period of the target vehicle 10 selected from the huge travel data of the plurality of vehicles 10. For example, in the case of estimating the damage of the friction material when traveling for 100,000 hours, the original data is traveling data over a predetermined period of the target vehicle 10.

In S110 process, the processing device 510 labels the original data by clustering. Specifically, the processing device 510 divides the original data at regular intervals. The length of the period for separating the original data is, for example, several minutes. Then, the processing device 510 performs clustering which is machine learning for grouping the data of each interval into a predetermined number of clusters. For example, k-means method is used as the algorithm of clustering. k-means method is a clustering algorithm for grouping data into a predetermined number of clusters. The clustering algorithm is not limited to k-means method.

The original data includes travel data collected under different environments, such as travel data when traveling in an urban area, travel data when traveling in a suburban area, and travel data when traveling on an expressway. By performing clustering, the travel data included in the original data can be grouped into clusters of travel data having similar characteristics. The number of clusters to be grouped is arbitrarily set according to the contents of the analysis.

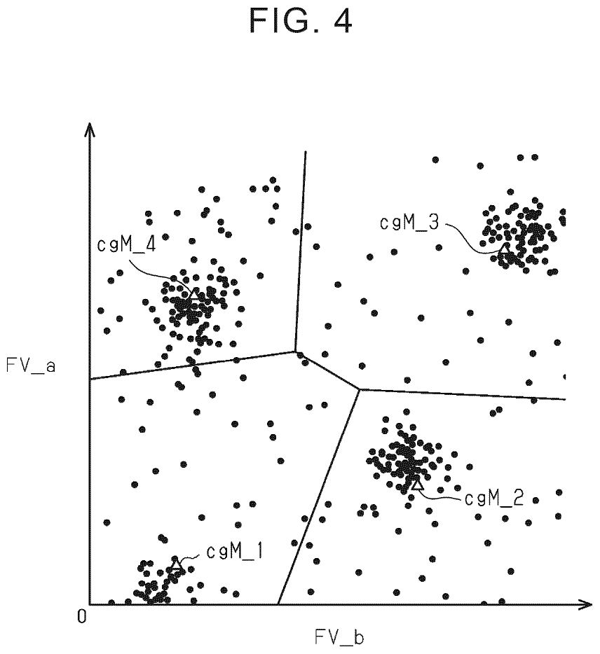

FIG. 4 is a graph illustrating an exemplary clustering of original data into four clusters by a k-means method using two features included in the original data as explanatory variables. For example, the two features are the amount of heat generation and the engagement frequency shown in FIG. 2. In FIG. 4, each piece of data in each interval partitioned from the original data is indicated by a single point. When performing clustering, the processing device 510 uses a representative value of an explanatory variable in the data of each interval. For example, the processing device 510 sets the average value of the features in the data of each interval as a representative value. The processing device 510 may use, as the representative value, the moving average value of the features in a plurality of consecutive intervals in time series.

In FIG. 4, these points are shown in a two-dimensional space with the first feature FV_a and the second feature FV_b as coordinate axes. FIG. 4 is an example in which original data is clustered in four clusters of the first cluster M_1, the second cluster M_2, the third cluster M_3, and the fourth cluster M_4. In FIG. 4, the boundaries of the four clusters are indicated by solid lines. In FIG. 4, the center of gravity of each cluster is indicated by an open triangle. The center of gravity cgM_1 is the center of gravity of the first cluster M_1. The center of gravity cgM_2 is the center of gravity of the second cluster M_2. The center of gravity cgM_3 is the center of gravity of the third cluster M_3. The center of gravity cgM_4 is the center of gravity of the fourth cluster M_4.

Although FIG. 4 shows two examples of explanatory variables, the number of explanatory variables is not limited to two. For example, when the original data includes three features, the processing device 510 may perform clustering using these three features as explanatory variables. In this case, the processing device 510 clusters the original data in the three-dimensional coordinate space.

The processing device 510 assigns a label indicating the result of the clustering in this way to the original data. Specifically, each data indicated by a point in the coordinate space is given a label for identifying a cluster in which the data is grouped. In this way, the processing device 510 creates the original data to which the label is attached.

Next, the processing device 510 calculates the relative frequency distribution of the original data in the processing of S120. As described above, the original data includes a plurality of features. The processing device 510 calculates a relative frequency distribution in the original data for each feature.

The frequency distribution classifies data into a plurality of classes, and represents a frequency distribution that is the number of data of each class. The relative frequency indicates how much the frequency of the class accounts for the sum of the total frequencies.

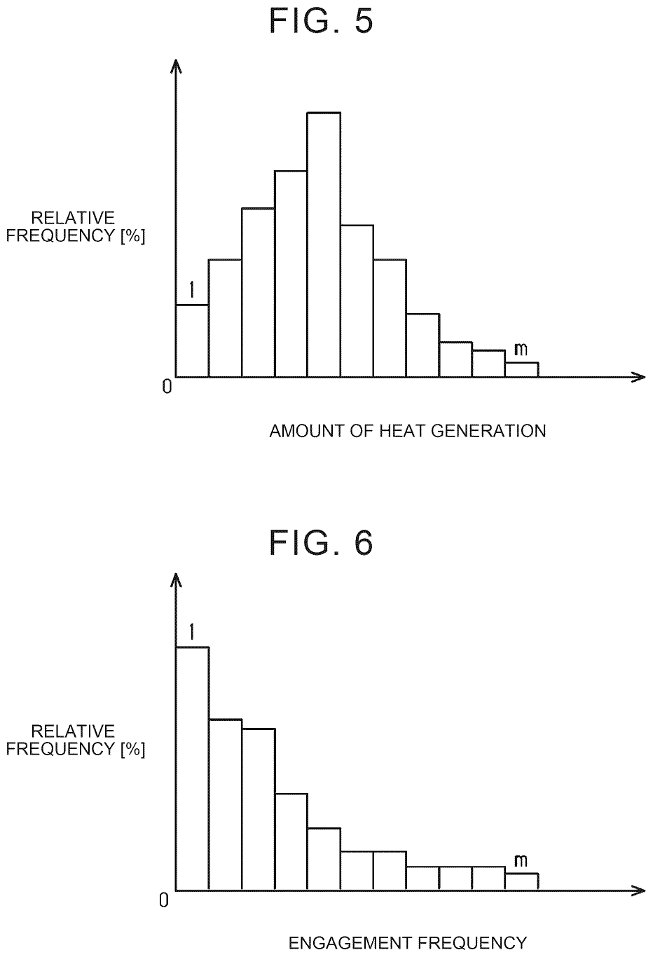

FIG. 5 shows the relative frequency distribution for the amount of heat generation in the original data shown in FIG. 2. In this relative frequency distribution, the scale of the amount of heat generation in the original data is divided into m classes from 1 to m, and the relative frequency distribution is shown.

FIG. 6 shows the relative frequency distribution for the engagement frequency in the original data shown in FIG. 2. In this relative frequency distribution, the rank of the engagement frequency in the original data is divided into m ranks from 1 to m, and the relative frequency distribution is shown.

In S120 process, the processing device 510 calculates the relative frequency distribution for the respective features included in the original data. The number of classes in the relative frequency distribution of each feature is the same.

For example, as in the example illustrated in FIG. 2, when the original data includes two features of the amount of heat generation and the engagement frequency as the features, the processing device 510 calculates the relative frequency distribution of each of the two features.

Next, in S125 process, the processing device 510 sets a plurality of time windows in order to extract the extracted data from the original data.

FIG. 2 shows three time windows W_1 to W_3 of the first time window W_1, the second time window W_2, and the third time window W_3 as an example of a plurality of time windows. In the example shown in FIG. 2, the time periods of each time window are all equal. As illustrated in FIG. 2, the data clipped according to each clipping window is data of each feature in the same period.

In S125 process, the processing device 510 randomly sets a plurality of time windows such that the total time period of all time windows is shorter than a predetermined period, which is the total time period of the original data. As will be described later, the processing device 510 combines all the data clipped by the plurality of time windows set here to create extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window each time S125 process is performed. At this time, the processing device 510 sets each time window so that each time window does not overlap. The processing device 510 thus randomly sets the plurality of time windows such that the total period of all time windows is a preset period. In S125 process, the processing device 510 may set a plurality of time windows by fixing the time periods of the time windows to be constant, as illustrated in FIG. 2. In S125 process, the processing device 510 may fix the plurality of time windows to a fixed number and set the plurality of time windows.

In addition to the above requirements, when setting a plurality of time windows through S125, the processing device 510 sets a plurality of time windows such that a difference between a proportion of each cluster in the extracted data and a proportion of each cluster in the entire original data is equal to or less than a threshold value.

In this way, by setting a plurality of time windows through S125 process, a clipping pattern in which data is clipped from the original data is determined. When the processing device 510 determines the clipping pattern in this way, the processing proceeds to S130.

In S130 process, the processing device 510 clips data from the original data in the determined clipping pattern. That is, in S130 process, the processing device 510 clips data from the original data by a plurality of set time windows. Then, the processing device 510 combines all the data clipped by the plurality of time windows to create extracted data.

In the process of the following S140, the processing device 510 calculates the relative frequency distribution of the extracted data. The processing device 510 calculates the relative frequency distribution of the extracted data in the same manner as the method of calculating the relative frequency distribution in S120. In other words, in S140 process, the processing device 510 calculates the relative frequency distribution of the extracted data for each feature. At this time, the processing device 510 sets the number of grades in the relative frequency distribution of the respective features to be the same as the relative frequency distribution in S120.

For example, as illustrated in FIG. 2, when the original data includes two features of the amount of heat generation and the engagement frequency as the features, the processing device 510 calculates the relative frequency distributions of the two features even in S140.

Next, in S145 process, the processing device 510 calculates an error between the relative frequency distribution in the original data and the relative frequency distribution in the extracted data. For example, the processing device 510 calculates a mean absolute error (MAE). The mean absolute error MAE is expressed by the following equation.

$$MAE = \frac{1}{n} {\sum }_{i = 1}^{n} {\sum }_{j = 1}^{m} \vert {Y}_{nm} - {y}_{nm} \vert$$

In the above equation, “n” is the number of feature quantities. “m” is the number of series in the relative frequency distribution. “Y” is the frequency of the corresponding feature in the original data in the corresponding class. “y” is the frequency of the corresponding feature in the extracted data in the corresponding class.

As shown in the above equation, the processing device 510 calculates, as an error, the sum of the errors of the frequencies in the respective classes for each feature between the relative frequency distribution in the entire original data and the relative frequency distribution in the extracted data.

After calculating the error, the processing device 510 advances the processing to S150. In S150 process, the processing device 510 determines whether or not the calculated error is less than or equal to the threshold value. The threshold value is a value for determining whether the extracted data having the relative frequency distribution close to the relative frequency distribution in the original data is extracted by the set clipping pattern. The magnitude of the threshold value is set in advance so that it can be determined that extracted data having a relative frequency distribution close to the relative frequency distribution in the original data is extracted based on the error being equal to or smaller than the threshold value.

In S150 process, when it is determined that the error is equal to or smaller than the threshold value (S150: YES), the processing device 510 advances the process to S160.

In S160 process, the processing device 510 calculates the index value using the extracted data created in the process of the latest S130. Here, an index value indicating the magnitude of the damage accumulated in the friction material is calculated. For example, the processing device 510 calculates a fatigue damage degree as an index value indicating the magnitude of damage accumulated in the friction material.

The fatigue damage degree is an index value representing a rate of accumulated fatigue, assuming that the damage of the friction material follows the linear cumulative damage law, the so-called minor law, with fatigue leading to damage as “1”. Here, the damage applied to the friction material during a certain period of time is calculated from the amount of heat generation and the engagement frequency. Then, the calculated ratio of the damage is calculated as an index value of the fatigue, with the magnitude of the damage that the friction material is damaged by the input of one load being set to “1”. By repeating this, the calculated index value of the fatigue is integrated to calculate the fatigue damage degree which is the ratio of the accumulated fatigue to the fatigue which reaches the damage. A fatigue damage degree of “1” means that the fatigue damage degree reaches damage, and the calculated fatigue damage degree is a value from “0” to “1”.

Here, since the fatigue damage degree is calculated using the extracted data which is a part of the original data, the processing device 510 converts the calculated fatigue damage degree into a size corresponding to the original data, and calculates the fatigue damage degree as the index value. For example, when the original data is traveling data for 100,000 hours and the extracted data is traveling data for 20,000 hours, the calculated fatigue damage degree is multiplied by five times to obtain the fatigue damage degree as the index value.

On the other hand, in S150 process, when it is determined that the error is larger than the threshold value (S150: NO), the processing device 510 returns the process to S125. Then, the processing device 510 performs the search process from $125 to S145 again.

In this way, the processing device 510 repeatedly performs S145 search processing from S125 by changing the settings of the plurality of time windows, and extracts extracted data in which the error becomes equal to or less than the threshold value from the original data. Then, the processing device 510 calculates an index value using the extracted data. After calculating the index value, the processing device 510 advances the processing to S170.

In S170 process, the processing device 510 determines whether or not the index value is equal to or greater than a predetermined value. The predetermined value is a value for predicting that damage is more likely to occur based on the fact that the index value is equal to or larger than the predetermined value. For example, “0.9” can be set here, for example, as a predetermined value in the fatigue damage degree. In this case, based on the fact that 90% of the fatigue leading to damage has been reached, it is possible to predict that there is a high possibility of damage.

In S170 process, when it is determined that the index value is equal to or greater than the predetermined value (S170: YES), the processing device 510 advances the process to S180. In S180 process, the processing device 510 outputs an index value and a failure prediction. Specifically, the processing device 510 transmits the index value and the failure prediction to the information processing terminal 600 that has transmitted the instruction for requesting the analysis.

The failure prediction is, for example, a message indicating that the occurrence of a failure has been predicted. In this way, when the calculated index value is equal to or greater than the predetermined value, the processing device 510 notifies that the occurrence of the failure has been predicted. The failure prediction may be information of a lifetime until a failure occurs. For example, when the fatigue damage degree calculated by using the extracted data extracted from the original data for 100,000 hours is the index value, the processing device 510 calculates the traveling time until the fatigue damage degree reaches “1” and outputs the calculated traveling time as the information of the life. The information on the life may be converted into the traveling distance based on the traveling distance of 100,000 hours and output.

In S170 process, when it is determined that the index value is less than the predetermined value (S170: NO), the processing device 510 advances the process to S190. In S190 process, the processing device 510 outputs an index value. Specifically, the processing device 510 transmits the index value to the information processing terminal 600 that has transmitted the instruction for requesting the analysis.

When S180 or S190 process is performed, the processing device 510 terminates the series of processes.

### Operation of the Embodiment

The data center 500, which is the information processing device of the present embodiment, acquires original data collected and created over a predetermined period using a plurality of sensors mounted on the vehicle 10, and calculates an index value indicating the magnitude of damage accumulated in the friction material of the automatic transmission 30.

The data center 500 includes a processing device 510 that performs processing. The original data includes, as features, data of the heat generation amount of the friction material of the automatic transmission 30 and data of the engagement frequency of the friction material of the automatic transmission 30. In the data center 500, the search process performed by the processing device 510 includes a first step (S120) of calculating, for each feature quantity, a relative frequency distribution in the original data for a plurality of feature quantities included in the original data. The searching process includes a second step (S125) of setting a plurality of time windows for clipping data of a part of the period of the original data such that the period of time of all the time windows is less than the predetermined period of time. The search process includes a third step (S130) of clipping data from the original data by a plurality of time windows. The search process includes a fourth step (S140) of calculating, for each feature, the relative frequency distribution in the extracted data obtained by combining all the data clipped by the plurality of time windows. The search process includes a fifth step (S145) of calculating an error between the relative frequency distribution in the original data and the relative frequency distribution in the extracted data. After performing the first step, the processing device 510 performs a search process in which the trial from the second step to the fifth step is repeatedly performed by changing the settings of a plurality of time windows. Then, the processing device 510 extracts the extracted data in which the error is equal to or less than the threshold value (S150: YES). The processing device 510 calculates an index value using the extracted data in which the error becomes equal to or smaller than the threshold value (S160).

According to the data center 500, it is possible to obtain extracted data that captures characteristics of the entire original data including a plurality of features. Therefore, the data center 500 can calculate the index value with the same accuracy as in the case of using the original data by using the extracted data having a smaller data amount than the original data.

### Effect of the Present Embodiment

(1) According to the data center 500 that is the information processing device of the present embodiment, it is possible to achieve both reduction in the amount of data and calculation accuracy of the index value.

(2) According to the data center 500 which is the information processing device of the present embodiment, it is possible to calculate the index value in a shorter time than in the case where the original data is used.

(3) The processing device 510 performs clustering, namely machine learning that groups data of each interval obtained by dividing the original data into intervals of a certain period into a predetermined number of clusters (S110). Then, in the second step (S125) of the search process, the processing device 510 sets a plurality of time windows such that the difference between the proportion of each cluster in the extracted data and the proportion of each cluster in the entire original data is equal to or less than the threshold value.

A plurality of intervals grouped into the same cluster is intervals having similar characteristics. In the above search process, the setting output from the processing device 510 is a setting in which the difference between the proportion of the entire original data and each cluster is equal to or less than the threshold value, and the extracted data having the relative frequency distribution of each feature close to each other can be clipped.

Therefore, according to the search process performed by the data center 500, it is possible to find a setting that can obtain extracted data closer to the characteristics of the entire original data.

(4) The processing device 510 terminates the search process when one piece of extracted data whose error becomes equal to or smaller than the threshold value can be extracted, and calculates an index value using the extracted data whose error becomes equal to or smaller than the threshold value. Therefore, the data center 500 can calculate an index value at a time point when one piece of extracted data whose error becomes equal to or smaller than the threshold value can be extracted, and output the result promptly.

(5) When the calculated index value is equal to or greater than the predetermined value (S170: YES), the processing device 510 notifies that a failure has been predicted. Therefore, the data center 500 can notify the user that the occurrence of the failure has been predicted before the failure occurs.

(6) The processing device 510 calculates the fatigue damage degree as the index value. Therefore, the data center 500 can inform the user of how long the delay until the failure is reached.

### Modifications

The present embodiment can be modified to be implemented as follows. The present embodiment and modifications described below may be carried out in combination within a technically consistent range.

As the features, the amount of heat generation of the friction material to be subjected to calculation of the index value of damage and the engagement frequency of the friction material have been exemplified, but the features may further include oil temperature data to calculate the index value.

In the above embodiment, an example in which the information processing device is embodied as the data center 500 has been described. An example in which the index value is calculated in the data center 500 has been described. On the other hand, the information processing device described above may be embodied as the information processing terminal 600. In this case, the calculation of the index value is performed by the processing device 610 of the information processing terminal 600. The above information processing device may be embodied as a control device of the vehicle 10. In this case, the calculation of the index value can also be performed by the control device of the vehicle 10. For example, the calculation of the index value may be performed by the transmission control device 50 of the vehicle 10.

In the above embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.

In the above embodiment, an example has been described in which, when the index value is equal to or larger than a predetermined value, it is notified that the occurrence of a failure has been predicted. This may be omitted. After the index value is calculated, only S190 process may be performed, and only the index value may be outputted.

Although the fatigue damage degree is exemplified as an example of the index value to be calculated, the index value to be calculated is not limited to the fatigue damage degree.

The index value of the damage of the plurality of friction materials may be calculated. The respective relative frequency distributions may be calculated for the feature quantities of the friction materials, and the clipping pattern may be searched so that the error of the relative frequency distributions for all the feature quantities becomes small.

The clipping pattern may be searched for so that the relative frequency distribution becomes smaller with respect to the feature quantity for each friction material. Then, the index value may be calculated for each friction material.

A transmission including a frictional material other than the automatic transmission 30 described in the above embodiment, such as a stepped automatic transmission mounted on a hybrid electric vehicle, a forward/reverse switching mechanism of a continuously variable transmission, and a clutch of a manual transmission, can also be targeted.

The processing device 510 sets a plurality of time windows such that a difference between a proportion of each cluster in the original data and a proportion of each cluster in the extracted data is equal to or smaller than a threshold value. Without such a restriction, the processing device 510 may set a plurality of time windows. In such cases, the process S110 clustering may be omitted.

The method of determining the setting of the time window in the clipping pattern may not be random. The trial may be repeated by changing the setting of the time window in the clipping pattern according to a preset rule.

The error calculated in S145 process is not limited to the mean absolute error MAE. For example, the processing device 510 may calculate a mean square error as an error. The processing device 510 may calculate a root mean square error as an error.

An example using extracted data obtained by combining all clipped data is shown. On the other hand, some of the clipped data may be combined to create extracted data.

What is claimed is:

1. An information processing device that acquires original data collected and created over a predetermined period using a plurality of sensors mounted on a vehicle and calculates an index value indicating a magnitude of damage accumulated in a friction material of a transmission, the information processing device comprising a processing device configured to perform a process, wherein:
the original data includes, as features, data on an amount of heat generation of the friction material of the transmission and data on an engagement frequency of the friction material of the transmission; and
the processing device is configured to
perform a search process, the search process including a first step of calculating, for each of a plurality of features included in the original data, a relative frequency distribution in the original data, a second step of setting a plurality of time windows for clipping data in a partial period of the original data in such a manner that a sum of periods of all the time windows is shorter than the predetermined period, a third step of clipping data from the original data according to the time windows, a fourth step of calculating, for each of the plurality of features, the relative frequency distribution in extracted data obtained by combining all the data clipped according to the time windows, and a fifth step of calculating an error between the relative frequency distribution in the original data and the relative frequency distribution in the extracted data, and after the first step is performed, a trial from the second step to the fifth step being repeatedly performed by changing settings of the time windows, and the processing device performing the search process to extract the extracted data with the error equal to or less than a threshold value, and
calculate the index value using the extracted data with the error equal to or less than the threshold value.

2. The information processing device according to claim 1, wherein:
the processing device is configured to perform clustering, the clustering being machine learning that groups data of each interval obtained by dividing the original data into intervals of a certain period into a predetermined number of clusters; and
the processing device is configured to set, in the second step, the time windows in such a manner that a difference between a proportion of each cluster in the extracted data and a proportion of each cluster in all of the original data is equal to or less than a threshold value.

3. The information processing device according to claim 1, wherein the processing device is configured to terminate the search process when one piece of the extracted data with the error equal to or less than the threshold value is extracted, and calculate the index value using the piece of the extracted data with the error equal to or less than the threshold value.

4. The information processing device according to claim 1, wherein the processing device is configured to, when the calculated index value is equal to or greater than a predetermined value, notify that a failure is predicted to occur.

5. The information processing device according to claim 1, wherein the processing device is configured to calculate a fatigue damage degree as the index value.
